(19) United States
(12) Patent Application Publication
(10) Pub. No.: US 2016/0023857 A1
(43) Pub. Date: Jan. 28, 2016

(54) RECORDING SHEET TRANSPORT DEVICE AND IMAGE READING DEVICE

(71) Applicant: FUJI XEROX CO., LTD., Tokyo (JP)

(72) Inventor: Ryusuke NAKATA, Kanagawa (JP)

(73) Assignee: FUJI XEROX CO., LTD., Tokyo (JP)

(21) Appl. No.: 14/613,457

(22) Filed: Feb. 4, 2015

(30) Foreign Application Priority Data
Jul. 28, 2014 (JP) 2014-153243

(51) Int. Cl. B65H 9/00; B65H 7/20; H04N 1/00; B65H 7/06

(52) U.S. Cl. CPC B65H 9/00; B65H 7/06; B65H 7/20; H04N 1/0057

(57) ABSTRACT

A recording sheet transport device having a transport path having a curvature includes a multifeed detector and an orientation stabilizing device. The multifeed detector detects a multifeed state in which two or more recording sheets are superposed on one another while the two or more recording sheets are being transported. The orientation stabilizing device stabilizes an orientation of parts of the two or more recording sheets, at which the multifeed state is detected by the multifeed detector, relative to the multifeed detector.

### CROSS-REFERENCE TO RELATED APPLICATIONS

This application is based on and claims priority under 35 USC 119 from Japanese Patent Application No. 2014-153243 filed Jul. 28, 2014.

### BACKGROUND

### Technical Field

The present invention relates to a recording sheet transport device and an image reading device.

### SUMMARY

A recording sheet transport device having a transport path having a curvature according to an aspect of the present invention includes a multifeed detector and an orientation stabilizing device. The multifeed detector detects a multifeed state in which two or more recording sheets are superposed on one another while the two or more recording sheets are being transported. The orientation stabilizing device stabilizes an orientation of parts of the two or more recording sheets, at which the multifeed state is detected by the multifeed detector, relative to the multifeed detector.

### BRIEF DESCRIPTION OF THE DRAWINGS

Exemplary embodiment of the present invention will be described in detail based on the following figures, wherein:

FIG. 1 is a side sectional view illustrating an image reading device according to an exemplary embodiment of the present invention;

FIG. 2 illustrates the details of a sheet feeding device of the image reading device illustrated in FIG. 1;

FIG. 3 is a see-through plan view of the interior of the sheet feeding device;

FIG. 4 is a see-through plan view of the sheet feeding device illustrated in FIG. 3 further seeing through an outer guide plate;

FIG. 5 is a sectional view of a portion of the sheet feeding device taken along line V-V in FIG. 3;

FIG. 6 is a perspective view illustrating a detailed structure of a pressure device;

FIG. 7 is a sectional view of a portion of the sheet feeding device taken along line VII-VII in FIG. 3;

FIG. 8 is a sectional view of a portion of the sheet feeding device taken along line VIII-VIII in FIG. 3;

FIG. 9 is a schematic view illustrating a state of a sheet or sheets bent between the two of the transport rollers while being supported by the two transport rollers; and

FIG. 10 is a plan view of a portion of the sheet feeding device corresponding to FIG. 3 illustrating a structure in which the pressure devices are provided at four positions adjacent to a part or parts of the sheet or the sheets so as to interpose the part or the parts therebetween in both the transport direction and the width direction of the sheet, the four positions being positions where whether or not a multifeed state occurs is detected by an ultrasonic wave sensor.

### DETAILED DESCRIPTION

An exemplary embodiment of the present invention will be described below with reference to the accompanying drawings.

### Description of an Image Reading Device

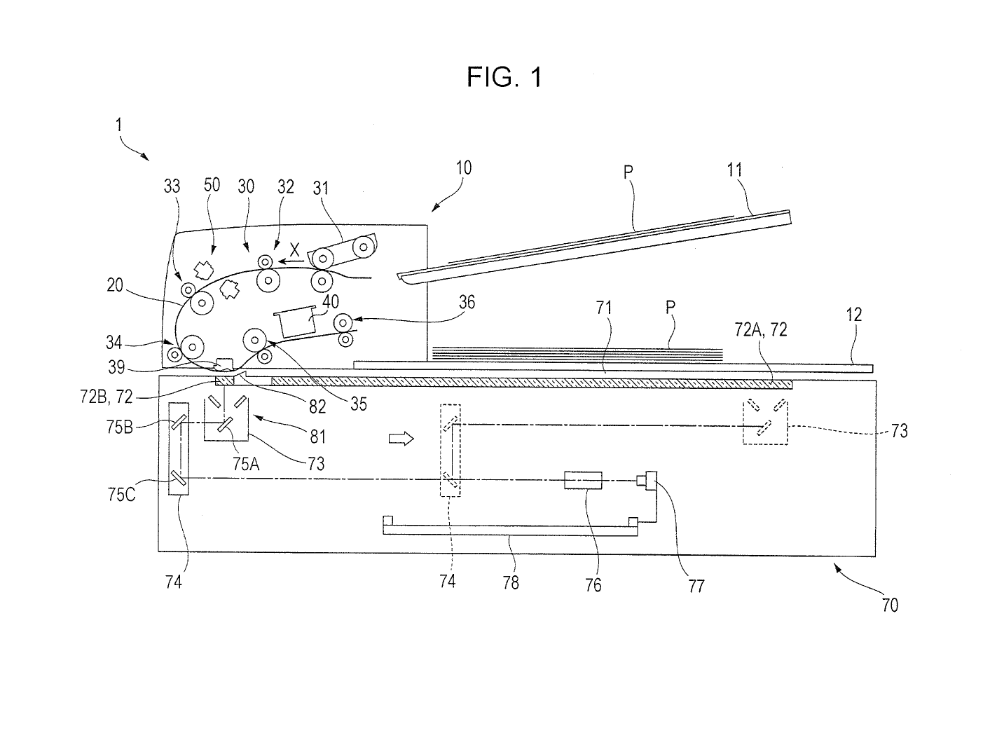

FIG. 1 is a side sectional view illustrating an image reading device 1 according to an exemplary embodiment of the present invention.

The image reading device 1 illustrated in FIG. 1 reads images held by sheets of paper P (each serving as an example of a recording sheet) as an original document so as to obtain image information corresponding to these images. The image reading device 1 includes a sheet feeding device 10 (serving as an example of a recording sheet transport device and an example of a recording sheet transport unit) and a scanner device 70. The sheet feeding device 10 sequentially transports each of the plural sheets P one after another from a batch of the sheets P including the plural sheets P batched together. The scanner device 70 reads the images from the sheets P.

### Sheet Feeding Device

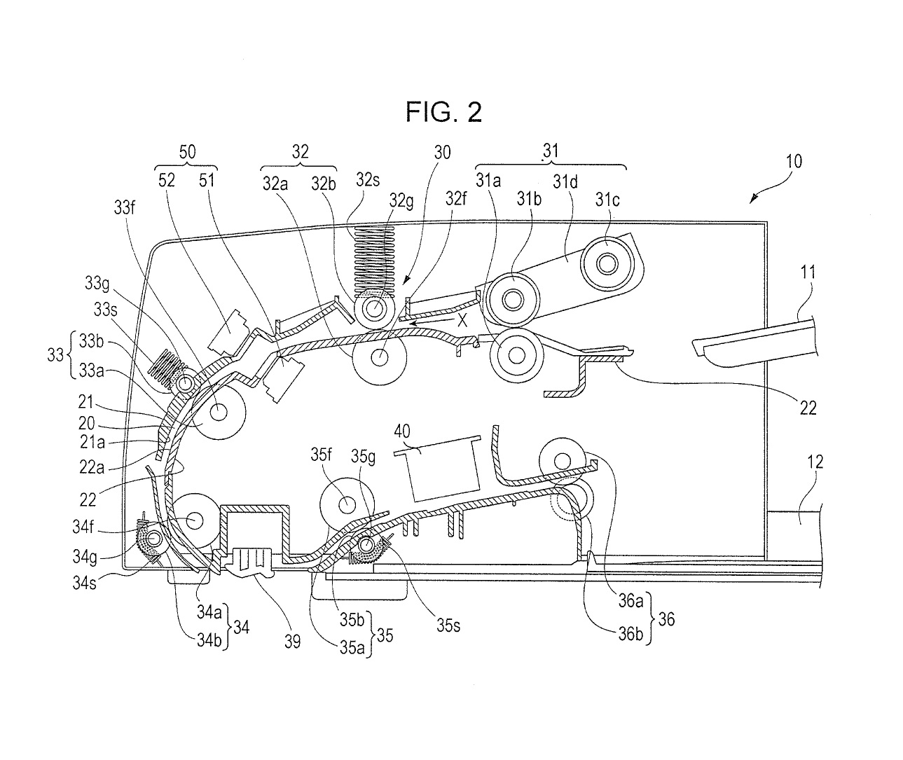

FIG. 2 illustrates the details of the sheet feeding device 10 illustrated in FIG. 1. The sheet feeding device 10 illustrated in, for example, FIG. 2, includes a sheet containing unit 11, a read sheet containing unit 12, a transport path 20, and a transport device 30. The batch of sheets are stacked on the sheet containing unit 11. The sheets P having been read (see FIG. 1) are stacked in the read sheet containing unit 12. The transport path 20 allows the sheets P to pass therethrough from the sheet containing unit 11 to the read sheet containing unit 12. The transport device 30 transports the sheets P along the transport path 20.

Hereafter, for convenience of description, in a state in which the sheets P are stacked in the sheet containing unit 11, a side of each of the sheets P facing the upper side of the image reading device 1 is referred to as a front side of the sheet P and a side of each of the sheets P facing the lower side of the image reading device 1 is referred to as a back side of the sheet P.

### Transport Path

The transport path 20 extends from the sheet containing unit 11 to the left in, for example, FIG. 2. A left end of this leftward extending part is continuous with a downwardly extending curved part having a curvature, the downwardly extending curved part extending counterclockwise. The transport path 20 further extends from a lower end of the downwardly extending curved part to the right in, for example, FIG. 2, toward the read sheet containing unit 12 at the lower right of the sheet feeding device 10. Here, “having a curvature” means that the curvature of the downward curved part of the transport path 20 is not zero.

As illustrated in detail in FIG. 2, the transport path 20 is defined by an inner guide plate 22 and an outer guide plate 21, which are spaced apart from each other by a distance greater than the thickness of each of the sheets P. The outer guide plate 21 is disposed radially outside the transport path 20, and the inner guide plate 22 is disposed radially inside the outer guide plate 21.

### Transport Device

The transport device 30 includes plural transport rollers and drive devices (not illustrated). The transport rollers are provided along the transport path 20. The drive devices drive the transport rollers. Specifically, these plural transport rollers include the following rollers sequentially from the upstream side in a transport direction X in which the sheets P (see FIG. 1) are transported along the transport path 20: delivery rollers 31, separation rollers 32, registration rollers 33, feed rollers 34, output rollers 35, and ejection rollers 36.

The delivery rollers 31 are the transport rollers that pick up the sheets P from the sheet containing unit 11 and deliver the sheets P to the transport path 20. The delivery rollers 31 include a first delivery roller 31a, a second delivery roller 31b, and a third delivery roller 31c. The first delivery roller 31a is formed of resin and disposed at the back side of the sheet P. The second delivery roller 31b and the third delivery roller 31c, which include respective rubber members wound on respective outer circumferential surfaces thereof, are disposed at the front side of the sheet P.

The second delivery roller 31b and the third delivery roller 31c are arranged in the transport direction X and supported by a support member 31d such that the second delivery roller 31b, the third delivery roller 31c, and the support member 31d are integrated with one another. The first delivery roller 31a and the second delivery roller 31b are in contact with each other. In a state in which the second delivery roller 31b is in contact with the first delivery roller 31a, the entirety of the integration of the support member 31d, the second delivery roller 31b, and the third delivery roller 31c is swingable about the second delivery roller 31b. When delivering the sheets P, the third delivery roller 31c is moved in an inclined path to a position where the third delivery roller 31c is brought into contact with the inner guide plate 22 and brought into contact with the inner guide plate 22.

By rotating the second delivery roller 31b and the third delivery roller 31c in synchronization with each other in the same direction (clockwise in the example illustrated in, for example, FIG. 2) with one or some of the drive devices (not illustrated), the sheets P are nipped between the inner guide plate 22 and the third delivery roller 31c so as to be transported downstream in the transport direction X along the transport path 20. The sheets P having been transported are then nipped between the second delivery roller 31b and the first delivery roller 31a so as to be transported further downstream in the transport direction X along the transport path 20.

The separation rollers 32 are the transport rollers that are provided downstream of the delivery rollers 31 in the transport direction X of the sheet P and separate the sheets P from one another so as to transport each of the sheets P further downstream in the transport direction X. The separation rollers 32 include a first separation roller 32a and a second separation roller 32b. The first separation roller 32a includes a rubber member wound on an outer circumferential surface thereof and is disposed at the back side of the sheet P. The second separation roller 32b is formed of resin and disposed at the front side of the sheet P.

The first separation roller 32a and the second separation roller 32b are in contact with each other. By rotating (counterclockwise in the example illustrated in, for example, FIG. 2) the first separation roller 32a with one or some of the drive devices (not illustrated), the sheets P fed from the delivery rollers 31 are each nipped between the first separation roller 32a and the second separation roller 32b so as to be transported further downstream in the transport direction X along the transport path 20.

The registration rollers 33 are the transport rollers that are provided downstream of the separation rollers 32 in the transport direction X of the sheet P and transport each of the sheets P further downstream in the transport direction X while adjusting the registration of the sheet P. The registration rollers 33 include a first registration roller 33a and a second registration roller 33. The first registration roller 33a includes a rubber member wound on an outer circumferential surface thereof and is disposed at the back side of the sheet P. The second registration roller 33b is formed of resin and disposed at the front side of the sheet P.

The first registration roller 33a and the second registration roller 33b are in contact with each other. By rotating (counterclockwise in the example illustrated in, for example, FIG. 2) the first registration roller 33a with one or some of the drive devices (not illustrated), the sheet P fed from the separation rollers 32 is nipped between the first registration roller 33a and the second registration roller 33b so as to be transported further downstream in the transport direction X along the transport path 20.

The feed rollers 34 are the transport rollers that are provided downstream of the registration rollers 33 in the transport direction X of the sheet P and transport the sheet P further downstream thereof in the transport direction X toward a platen member 39 provided between the feed rollers 34 and the output rollers 35. The feed rollers 34 include a first feed roller 34a and a second feed roller 34b. The first feed roller 34a includes a rubber member wound on an outer circumferential surface thereof and is disposed at the back side of the sheet P. The second feed roller 34b is formed of resin and disposed at the front side of the sheet P.

The first feed roller 34a and the second feed roller 34b are in contact with each other. By rotating (counterclockwise in the example illustrated in, for example, FIG. 2) the first feed roller 34a with one or some of the drive devices (not illustrated), the sheet P fed from the registration rollers 33 is nipped between the first feed roller 34a and the second feed roller 34b so as to be transported further downstream in the transport direction X along the transport path 20.

The platen member 39 sets the sheet P fed from the feed rollers 34 in a state in which the front side of the sheet P is pressed against a first platen glass 72a of the scanner device 70 (see FIG. 1). The sheet P having passed through the platen member 39 is guided upward along an inclined surface of a guide member 82 provided on a document table 71 of the scanner device 70 and transported along the transport path 20 toward the output rollers 35 disposed further downstream in the transport direction X.

As illustrated in FIG. 2, the output rollers 35 are the transport rollers that are provided downstream of the platen member 39 in the transport direction X of the sheet P and transport the sheet P further downstream in the transport direction X. The output rollers 35 include a first output roller 35a and a second output roller 35b. The first output roller 35a includes a rubber member wound on an outer circumferential surface thereof and is disposed at the back side of the sheet P. The second output roller 35b is formed of resin and disposed at the front side of the sheet P.

The first output roller 35a and the second output roller 35b are in contact with each other. By rotating (counterclockwise in the example illustrated in, for example, FIG. 2) the first output roller 35a with one or some of the drive devices (not illustrated), the sheet P having passed through the platen member 39 is nipped between the first output roller 35a and the second output roller 35b so as to be transported further downstream in the transport direction X along the transport path 20.

The ejection rollers 36 are the transport rollers that are provided downstream of the output rollers 35 in the transport direction X of the sheet P and transport the sheet P to the read sheet containing unit 12 disposed downstream of the ejection rollers 36 in the transport direction X. The ejection rollers 36 include a first ejection roller 36a and a second ejection roller 36b. The first ejection roller 36a and the second ejection roller 36b include respective rubber members wound on respective outer circumferential surfaces thereof and are respectively disposed at the back side and the front side of the sheet P.

The first ejection roller 36a and the second ejection roller 36b are in contact with each other. By rotating (counterclockwise in the example illustrated in, for example, FIG. 2) the first ejection roller 36a with one or some of the drive devices (not illustrated), the sheet P fed from the output rollers 35 is nipped between the first ejection roller 36a and the second ejection roller 36b so as to be ejected to the read sheet containing unit 12.

The above-described separation rollers 32, the registration rollers 33, the feed rollers 34, and the output rollers 35 are disposed such that the common tangents to first rollers disposed on the inner guide plate 22 side (first separation roller 32a, first registration roller 33a, first feed roller 34a, and first output roller 35a) and respective second rollers disposed on the outer guide plate 21 side (second separation roller 32b, second registration roller 33b, second feed roller 34b, and second output roller 35b) extend along the transport path 20.

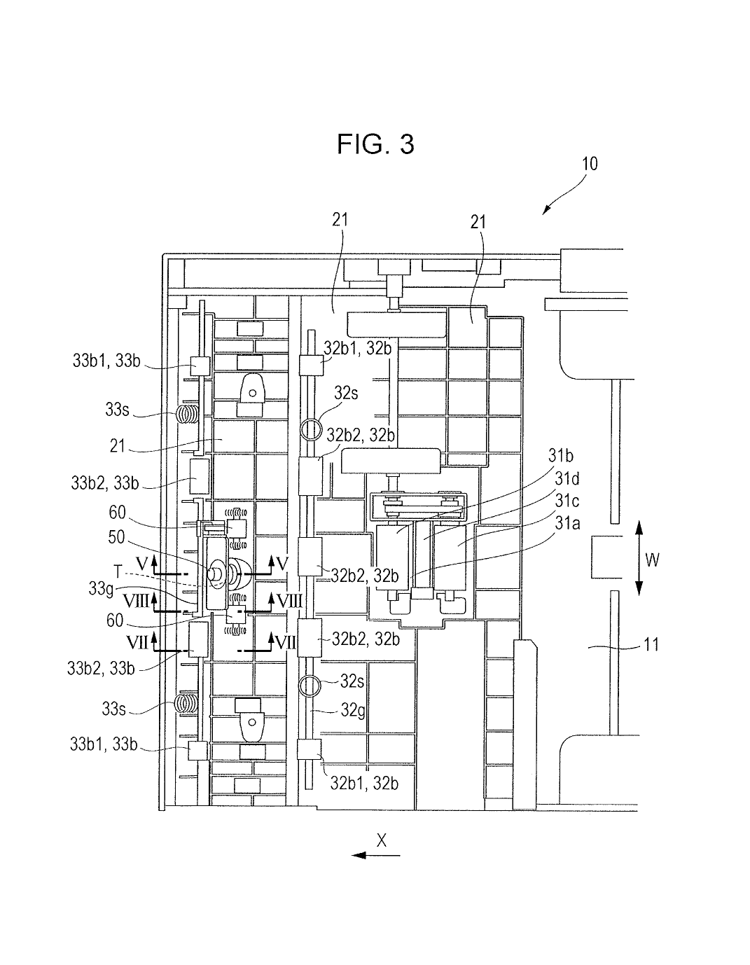

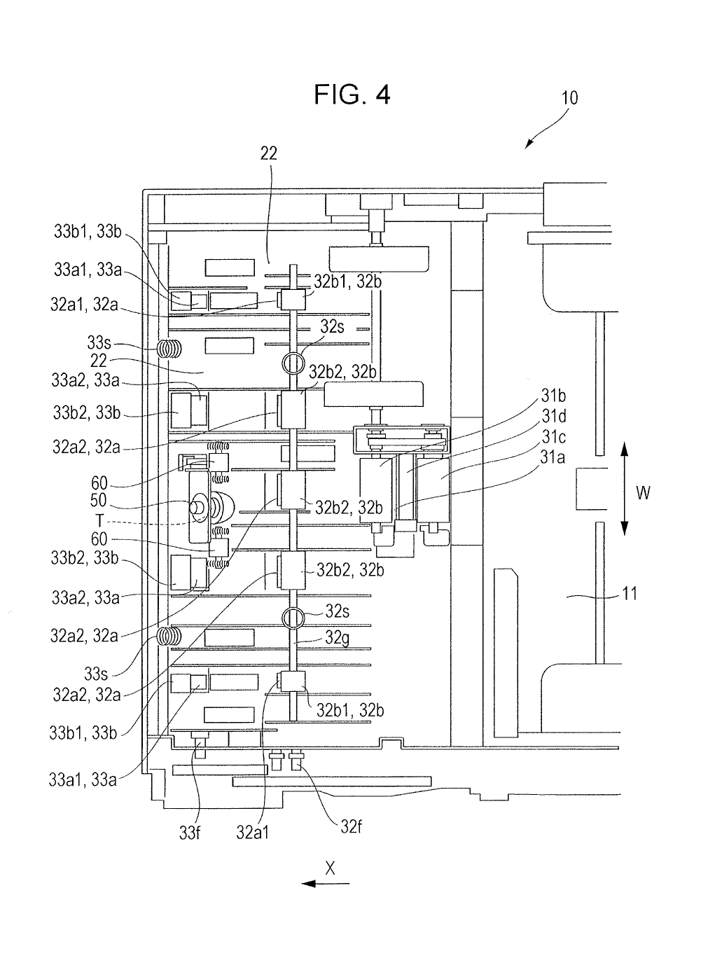

FIG. 3 is a see-through plan view of the interior of the sheet feeding device 10. FIG. 4 is a see-through plan view of the sheet feeding device 10 illustrated in FIG. 3 further seeing through the outer guide plate 21.

Out of the above-described transport rollers, the first delivery roller 31a, the second delivery roller 31b, and the third delivery roller 31c are, as illustrated in FIG. 3, provided at respective single positions in a central portion in a width direction W (perpendicular to the transport direction X) of the sheet P to be transported.

As illustrated in FIG. 4, five first separation rollers 32a are provided at five different positions, respectively, in the width direction W of the sheet P to be transported and five second separation rollers 32b are provided at five different positions, respectively, in the width direction W of the sheet P to be transported. Out of these five sets of the first separation rollers 32a and the second separation rollers 32b, two first separation rollers 32a at both the ends in the width direction W are referred to as first separation rollers 32a1 and three first separation rollers 32a near the center in the width direction W (that is, not at both the ends) are referred to as first separation rollers 32a2, and two second separation rollers 32b at both the ends in the width direction W are referred to as second separation rollers 32b1 and three second separation rollers 32b near the center (that is, not at both the ends) are referred to as second separation rollers 32b2. The first separation rollers 32a1 and the second separation rollers 32b1 have shorter lengths than those of the first separation rollers 32a2 and the second separation rollers 32b2, respectively.

Furthermore, three sets of the first separation rollers 32a2 and the second separation rollers 32b2 near the center in the width direction W are disposed at positions where the first separation rollers 32a2 and the second separation rollers 32b2 are brought into contact with the sheet P even when the size of the sheet P being fed is, for example, B5, A4, or the like having a comparatively small width. Furthermore, two sets of the first separation rollers 32a1 and the second separation rollers 32b1 at both the ends in the width direction W are disposed at positions where the first separation rollers 32a1 and the second separation rollers 32b1 are brought into contact with the sheet P only when the size of the sheet P being fed is, for example, B4, A3, or the like having a comparatively large width.

Herein, in the case where the distinction between the two first separation rollers 32a1 at both the ends and the three first separation rollers 32a2 near the center is not particularly required, these rollers may also be simply referred to as the first separation rollers 32a. Likewise, in the case where the distinction between two second separation rollers 32b1 at both the ends and three second separation rollers 32b2 near the center is not particularly required, these rollers may also be simply referred to as the second separation rollers 32b.

These five first separation rollers 32a are secured to a common shaft 32f that extends in the width direction W. As this shaft 32f is rotated by the one or some of the drive devices (not illustrated), the five first separation rollers 32a are also rotated together with the shaft 32f.

Also, the five second separation rollers 32b are secured to a common shaft 32g that extends in the width direction W. This shaft 32g is in contact with compression springs 32s. Elastic forces produced in the axial directions of these compression springs 32s press the shaft 32g toward the shaft 32f, thereby bringing the second separation rollers 32b into pressure contact with the first separation rollers 32a. The second separation rollers 32b are rotated by contact with the first separation rollers 32a or by contact with the sheet P fed by the first separation rollers 32a.

As illustrated in FIG. 4, four first registration rollers 33a are provided at four different positions, respectively, in the width direction W of the sheet P to be transported and four second registration rollers 33b are provided at four different positions, respectively, in the width direction W of the sheet P to be transported. Out of these four sets of the first registration rollers 33a and the second registrations rollers 33b, two first registration rollers 33a at both the ends in the width direction W are referred to as first registration rollers 33a1 and two first registration rollers 33a near the center (that is, not at both the ends) in the width direction W are referred to as first registration rollers 33a2, and two second registration rollers 33b at both the ends in the width direction W are referred to as second registration rollers 33b1 and two second registration rollers 33 near the center (that is, not at both the ends) are referred to as second registration rollers 33b2. The first registration rollers 33a1 and the second registration rollers 33b1 have shorter lengths in the width direction W than those of the first registration rollers 33a2 and the second registration rollers 33b2, respectively.

With respect to the width direction W, two first registration rollers 33a2 near the center are respectively disposed at the same positions as those of the first separation rollers 32a2 disposed on the end sides among the three first separation rollers 32a2, and the two second registration rollers 33b2 near the center are respectively disposed at the same positions as those of the second separation rollers 32b2 disposed on the end sides among the three second separation rollers 32b2.

Also with respect to the width direction W, the two first registration rollers 33a1 and the two second registration rollers 33b1 at both the ends are respectively disposed at the same positions as those of the two sets of the first separation rollers 32a1 and the second separation rollers 32b1 at both the ends.

Herein, in the case where the distinction between the two first registration rollers 33a1 at both the ends and the two first registration rollers 33a2 near the center is not particularly required, these rollers may also be simply referred to as the first registration rollers 33a. Also, in the case where the distinction between the two second registration rollers 33b1 at both the ends and the two second registration rollers 33b2 near the center is not particularly required, these rollers may also be simply referred to as the second registration rollers 33b.

These four first registration rollers 33a are secured to a common shaft 33f that extends in the width direction W. As this shaft 33f is rotated by the one or some of the drive devices (not illustrated), the four first registration rollers 33a are also rotated together with the shaft 33f.

Also, the four second registration rollers 33b are secured to a common shaft 33g that extends in the width direction W. This shaft 33g is in contact with compression springs 33s. Elastic forces produced in the axial directions of these compression springs 33s press the shaft 33g toward the shaft 33f, thereby bringing the second registration rollers 33b into pressure contact with the first registration rollers 33a. The second registration rollers 33b are rotated by contact with the first registration rollers 33a or by contact with the sheet P fed by the first registration rollers 33a.

As is the case with the first registration rollers 33a and the second registration rollers 33b, with respect to the width direction W of the sheet P to be transported, four first feed rollers 34a (see FIG. 2) are respectively provided at four different positions, four second feed rollers 34b are respectively provided at four different positions, four first output rollers 35a are respectively provided at four different positions, and four second output rollers 35b are respectively provided at four different positions. The first feed rollers 34a, the second feed rollers 34b, the first output rollers 35a, and the second output rollers 35b are respectively secured to common shafts 34f, 34g, 35f, and 35g.

As the common shaft 34f of the first feed rollers 34a is rotated by the one or some of the drive devices, the four first feed rollers 34a are rotated together with the common shaft 34f, and as the common shaft 35f of the first output rollers 35a is rotated by the one or some of the drive devices, the four first output rollers 35a are rotated together with the common shaft 35f.

Furthermore, an extension spring 34s or extension springs 34s are in contact with the common shaft 34g of the second feed rollers 34b. An elastic force or elastic forces generated in the thrust direction of the extension spring 34s or the extension springs 34s press the shaft 34g toward the shaft 34f, thereby bringing the second feed rollers 34b into pressure contact with the first feed rollers 34a. The second feed rollers 34b are rotated by contact with the first feed rollers 34a or by contact with the sheet P (see FIG. 1) fed by the first feed rollers 34a.

Likewise, an extension spring 35s or extension springs 35s are in contact with the common shaft 35g of the second output rollers 35b. An elastic force or elastic forces generated in the thrust direction of the extension spring 35s or the extension springs 35s press the shaft 35g toward the shaft 35f, thereby bringing the second output rollers 35b into pressure contact with the first output rollers 35a. The second output rollers 35b are rotated by contact with the first output rollers 35a or by contact with the sheet P fed by the first output rollers 35a.

Among four types of the transportation rollers (the separation rollers 32, the registration rollers 33, the feed rollers 34, and the output rollers 35) provided along the transport path 20, a type of the transport rollers provided on the relatively downstream side in the transport direction X are driven at a higher rotational speed than that at which a type of the transport rollers provided on the relatively upstream side in the transport direction X are rotated.

Depending on the relationship between the pitch of two types of the transport rollers adjacent to each other in the transport direction X and the length of the sheet P (the dimension of the sheet P in the transport direction X), the sheet P is transported through the transport path 20 in the transport direction X while being nipped between one or two types of the transport rollers. When the sheet P is nipped between two types of the transport rollers, since the rotational speed of the transport rollers is higher on the downstream side than on the upstream side in the transport direction X, the sheet P is stretched with the slack thereof reduced in part of the transport path 20 between the two types of the transport rollers. Accordingly, the sheet P is transported along an inner guide surface 22a of the inner guide plate 22 of the transport path 20 having a curvature.

In the present exemplary embodiment, the inner guide surface 22a itself, which is disposed on the inner side of the transport path 20 having a curvature, is a convex surface. However, this does not limit the form of the inner guide surface 22a. The inner guide plate 22 is not necessarily disposed in the entire range of the transport path 20 having a curvature. The inner guide surface 22a may have a linear shape as long as the transport path 20 has a curvature.

### Ultrasonic Wave Sensor

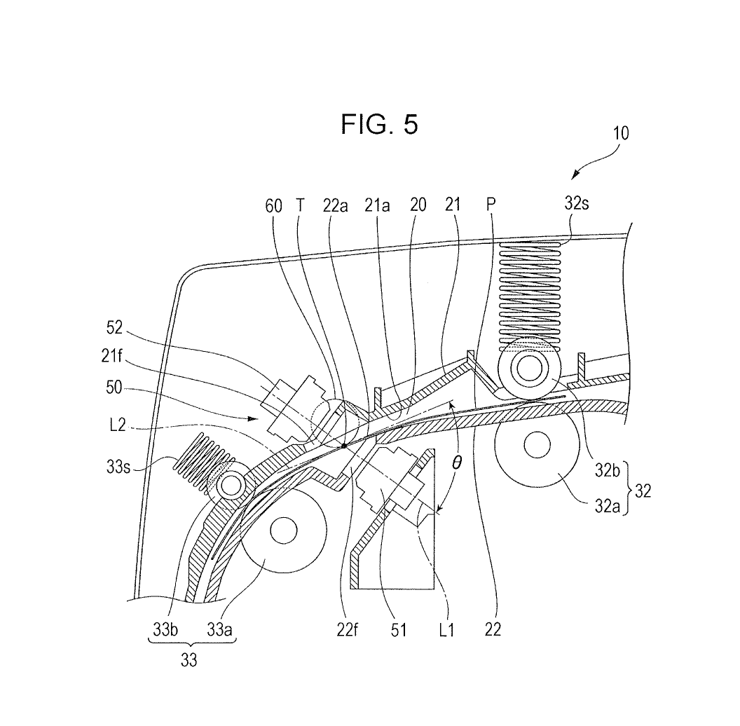

FIG. 5 is a sectional view of a portion of the sheet feeding device 10 taken along line V-V in FIG. 3. As illustrated in FIG. 5, the sheet feeding device 10 includes an ultrasonic wave sensor 50 (serving as an example of a multifeed detector) that detects a multifeed state. In the multifeed state, two or more of the sheets P passing through part of the transport path 20 between the separation rollers 32 and the registration rollers 33, the part having a curvature, are superposed on one another while being transported. As illustrated in FIGS. 3 and 4, the ultrasonic wave sensor 50 is disposed between the separation rollers 32 and the registration rollers 33 in the transport direction X at a central portion in the width direction W of the sheet P.

The ultrasonic wave sensor 50 includes a transmitter 51 that transmits an ultrasonic wave and a receiver 52 that receives an ultrasonic wave. In the sheet feeding device 10, as an example arrangement of the ultrasonic wave sensor 50, the transmitter 51 is disposed on the inner guide plate 22 side with respect to the transport path 20 and the receiver 52 is disposed on the outer guide plate 21 side with respect to the transport path 20. However, the transmitter 51 may be disposed on the outer guide plate 21 side and the receiver 52 may be disposed on the inner guide plate 22 side.

The transmitter 51 is secured at a position outside the inner guide plate 22 with respect to the transport path 20 and the receiver 52 is secured at a position outside the outer guide plate 21 with respect to the transport path 20. A transmitting surface of the transmitter 51 and a receiving surface of the receiver 52 face each other with the sheet P or the sheets P transported through the transport path 20 interposed therebetween.

The receiver 52 of the ultrasonic wave sensor 50 receives an ultrasonic wave transmitted from the transmitter 51 of the ultrasonic wave sensor 50. The ultrasonic wave sensor 50 detects whether or not the multifeed state occurs in accordance with the magnitude of a signal level of the received ultrasonic wave. Thus, in order for the receiver 52 to receive the ultrasonic wave transmitted from the transmitter 51, a hole 22f and a hole 21f are respectively formed at parts of the inner guide plate 22 and the outer guide plate 21 where the ultrasonic wave from the transmitter 51 to the receiver 52 passes through so as to allow the ultrasonic wave to pass therethrough.

Whether or not the multifeed state occurs is detected at part T or parts T where a line L1, which connects the transmitter 51 and the receiver 52 and along which the ultrasonic wave passes, intersects the sheet P or the sheets P passing through the transport path 20.

The ultrasonic wave sensor 50 is inclined relative to the sheet P or the sheets P at the part T or the parts T of the sheet P or the sheets P where whether or not the multifeed state occurs is detected. That is, as illustrated in FIG. 5, the following angle θ (an example of an orientation of the sheet P or the sheets P relative to the ultrasonic wave sensor 50) is set to an angle other than 90 degrees, for example, in an angular range from 60 to 70 degrees: the angle θ is formed between the line L1 connecting the transmitter 51 and the receiver 52 of the ultrasonic wave sensor 50 and a line L2, which is a tangent to the sheet P or the sheets P at the part T or the parts T of the sheet P or the sheets P that intersect the line L1 (tangent to the sheet P or the sheets P along the inner guide surface 22a of the inner guide plate 22 that defines the transport path 20).

The angle θ formed between the line L1 and the tangent L2 is determined in accordance with the specifications (type, thickness, and so forth) of the sheets P and the specifications of the ultrasonic wave sensor 50 to be used. The angle θ is not limited to an angle in the angular range from 60 to 70 degrees as long as whether or not the multifeed state occurs is clearly determined.

### Pressure Devices

AS illustrated in FIG. 5, the sheet feeding device 10 according to the present exemplary embodiment includes pressure devices 60. The pressure devices 60 each serve as an example of an orientation stabilizing device and stabilize the orientation (angle θ in the present exemplary embodiment) of the sheet P or the sheets P relative to the ultrasonic wave sensor 50 at the part T or the parts T of the sheet P or the sheets P where whether or not the multifeed state occurs is detected by the ultrasonic wave sensor 50.

The pressure devices 60 are disposed in the outer guide plate 21 and press the sheet P or the sheets P at the part T or the parts T against the inner guide surface 22a. Here, the inner guide surface 22a is a convex surface, and the pressure devices 60 press the sheet P or the sheets P from outside this convex surface. The pressure devices 60 press the part T or the parts T at the sheet P or the sheets P against the inner guide surface 22a, thereby suppressing variation of the orientation of the part T or the parts T of the sheet P or the sheets P.

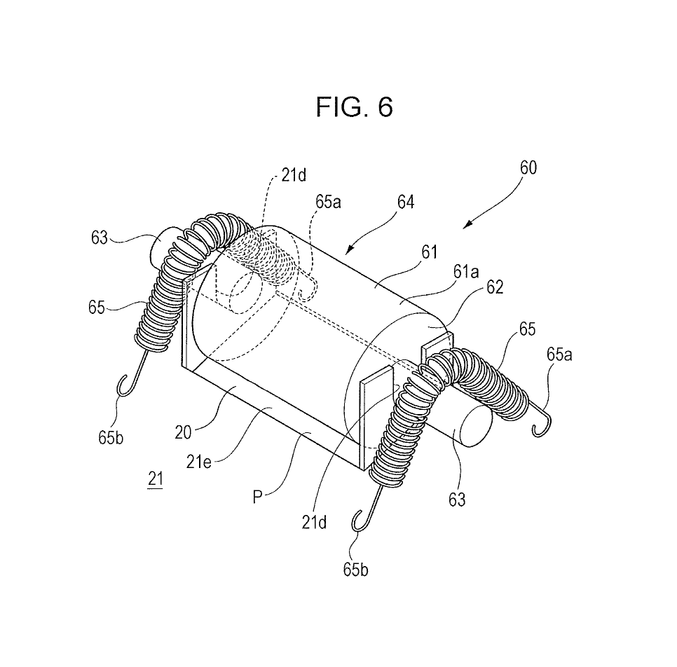

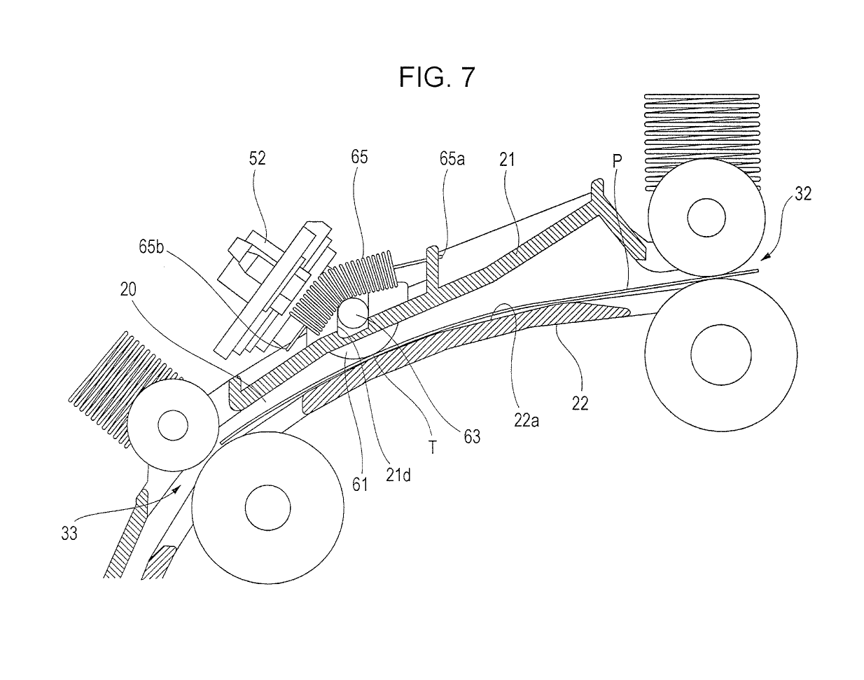

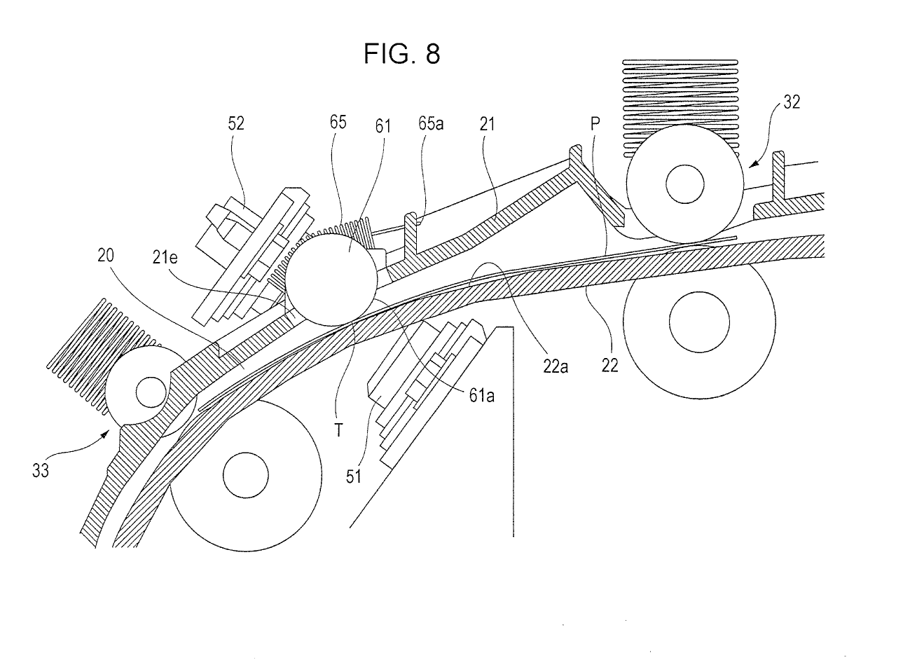

FIG. 6 is a perspective view illustrating a detailed structure of each of the pressure devices 60. FIG. 7 is a sectional view of a portion of the sheet feeding device 10 taken along line VII-VII in FIG. 3. FIG. 8 is a sectional view of a portion of the sheet feeding device 10 taken along line VIII-VIII in FIG. 3.

As illustrated in FIG. 6, each of the pressure devices 60 includes a roller 64 and extension springs 65. The roller 64 includes a pressure portion 61, which has a cylindrical shape and is rotatable about the axis, and shaft portions 63 projecting from respective end surfaces 62 of the pressure portion 61 in the axial direction of the cylindrical shape. The extension springs 65 apply pressing forces to the roller 64.

The outer guide plate 21 has two bearings 21d for each of the pressure devices 60, which project on a side of a surface of the outer guide plate 21 opposite to an outer guide surface 21a (see FIG. 2) and face the transport path 20. The shaft portions 63 of the rollers 64 are rotatably supported by the bearings 21d. Furthermore, the outer guide plate 21 has an opening 21e for each of the pressure devices 60 formed between the two bearings 21d. As illustrated in FIG. 8, the pressure portion 61 of the roller 64, of which the shaft portions 63 are supported by the bearings 21d, is partially projects to the transport path 20 through the opening 21e. An outer circumferential surface 61a of the projecting part of the pressure portion 61 is in contact with the sheet P.

The extension springs 65 are disposed on the respective shaft portions 63 (see FIG. 6), which are supported by the bearings 21d, from an outer side. The extension springs 65 apply elastic forces that press the shaft portions 63 from the outer side toward the bearings 21d. Each of the extension springs 65 is disposed on a corresponding one of the shaft portions 63 while being extended within a range of elastic deformation, and, as illustrated in FIG. 7, both ends 65a and 65b are secured to the outer guide plate 21.

Thus, elastic forces in the thrust directions of the extension springs 65 are applied to the shaft portions 63, thereby causing the outer circumferential surface 61a of the pressure portion 61 to press the sheet P or the sheets P against the inner guide surface 22a as illustrated in FIG. 8.

As illustrated in FIGS. 3 and 4, two pressure devices 60 are provided in the width direction W with the part T or the parts T of the sheet P or the sheets P interposed therebetween.

### Image Reading Unit

As illustrated in FIG. 2, the sheet feeding device 10 includes a second image reading unit 40 between the output rollers 35 and the ejection rollers 36 in the transport path 20. The second image reading unit 40 reads an image held on the back side of each of the sheets P (see FIG. 1) so as to obtain image information. The second image reading unit 40 serves as an example of image reading unit that is provided downstream of the pressure devices 60 in the transport direction X along the transport path 20 and reads an image recorded on the sheet P so as to obtain image information.

The second image reading unit 40 includes a linear light source and a line sensor. The linear light source radiates linear light, which extends in a direction intersecting the transport direction X, toward the sheet P transported in part of the transport path 20 between the output rollers 35 and the ejection rollers 36. The line sensor photoelectrically reads the linear reflected light reflected by the image held on the rear side of the sheet P, the linear reflected light outgoing from the rear side of the sheet P irradiated with the linear light.

As will be described later, while the sheet P is transported between the feed rollers 34 and the output rollers 35 in the transport path 20, the sheet P is pressed against a second platen glass 72B of the scanner device 70 (see FIG. 1) by the platen member 39 and the image held on the front side of the sheet P is read by the scanner device 70 through the second platen glass 72B.

Here, the scanner device 70 also serves as an example of the image reading unit that is provided downstream of the pressure devices 60 in the transport direction X along the transport path 20 and reads an image recorded in the sheet P so as to obtain image information.

### Scanner Device

As illustrated in FIG. 1, the scanner device 70 supports the above-described sheet feeding device 10 such that the sheet feeding device 10 is openable. The scanner device 70 reads an image held on the front side of the sheet P transported by the sheet feeding device 10.

The scanner device 70 includes the first platen glass 72A and the second platen glass 72B. The sheet P is not moved and placed on the first platen glass 72A when being read. The second platen glass 72B is an opening for light for reading an image on the front side of the sheet P while the sheet P is transported by the above-described sheet feeding device 10.

In the following description, the first platen glass 72A and the second platen glass 72B are referred to as platen glasses 72 in the case where the first platen glass 72A and the second platen glass 72B are not distinguished from each other.

The scanner device 70 includes a full rate carriage 73 and a half rate carriage 74. The full rate carriage 73 scans the entirety of the first platen glass 72A so as to read an image from below the first platen glass 72A or reads an image while being stationary below the second platen glass 72B. The half rate carriage 74 supplies reflected light obtained from the full rate carriage 73 to an imaging unit.

The full rate carriage 73 includes a scanner light source 81 and a first mirror 75A. The scanner light source 81 radiates light toward the sheet P. The first mirror 75A receives the reflected light obtained from the sheet P. The half rate carriage 74 includes a second mirror 75B and a third mirror 75C, which reflect the reflected light obtained from the first mirror 75A to the imaging unit.

Furthermore, the scanner device 70 includes an imaging lens 76 and a charge-coupled device (CCD) image sensor 77. Out of these, the imaging lens 76 optically reduces the size of an image of the reflected light reflected by the third mirror 75C to a size so that the image of the reflected light is formed on the CCD image sensor 77.

The CCD image sensor 77 receives an optical image reduced in size by the imaging lens 76 and performs photoelectrical conversion on the received image so as to obtain an electrical signal, thereby reading the image as image information.

The scanner device 70 further includes a controller 78. The controller 78 controls each component of the scanner device 70 in an image reading operation of the scanner device 70 and performs processes and the like on image data having been read. The controller 78 also controls operations of various motors serving as the drive devices and transport rollers of the sheet feeding device 10, the image reading operation and so forth in the second image reading unit 40. The above-described functions of the controller 78 are realized by a central processing unit (CPU) controlled by a program.

Furthermore, the scanner device 70 includes the guide member 82 disposed between the first platen glass 72A and the second platen glass 72B. The guide member 82 has the inclined surface along which each of the sheets P having passed through a space between the second platen glass 72B and the platen member 39 is guided toward the output rollers 35 by the sheet feeding device 10.

### Operations of the Image Reading Device

Next, operations of the image reading device 1 according to the present exemplary embodiment are described.

Initially, before the sheets P are transported from the sheet containing unit 11 through the transport path 20, the full rate carriage 73 and the half rate carriage 74 of the scanner device 70 are stopped and wait for the sheets P at positions indicated by solid lines in FIG. 1.

The transport rollers are driven by the drive devices of the sheet feeding device 10 under the control of the controller 78. The sheets P contained in the sheet containing unit 11 are delivered by the delivery rollers 31 to the transport path 20 and transported downstream in the transport direction X along the transport path 20. The sheets P transported along the transport path 20 are separated from one another by the separation rollers 32 and are each transported downstream in the transport direction X one after another along the transport path 20.

when the leading end of the sheet P or the sheets P reaches the registration rollers 33, registration of the sheet P or the sheets P is adjusted and whether or not the multifeed state of the sheets P occurs is detected by the ultrasonic wave sensor 50. At this time, as illustrated in FIG. 4, side portions in the width direction W of the sheet P (see FIG. 5) adjacent to each other with the part T or the parts T interposed therebetween, the part T or the parts T being part where whether or not the multifeed state occurs is detected by the ultrasonic wave sensor 50, are pressed against the inner guide surface 22a (see FIG. 5) by the pressure devices 60. Thus, the part T or the parts T of the sheet P or the sheets P are also pressed against the inner guide surface 22a, and accordingly, the orientation relative to the ultrasonic wave sensor 50 may be stabilized.

Accordingly, variation of the angle θ formed between the ultrasonic wave sensor 50 and the sheet P or the sheets P may be prevented or suppressed. With the orientation of the sheet P or the sheets P relative to the ultrasonic wave sensor 50 stabilized, variation in results of detection of whether or not the multifeed state of the sheets P occurs performed by the ultrasonic wave sensor 50 may be suppressed compared to the case where the orientation of the sheet P or the sheets P is not stabilized.

When multifeed is detected as a result of the detection of whether or not the multifeed state occurs performed by the ultrasonic wave sensor 50, drive of the drive devices is stopped under the control of the controller 78 (see FIG. 1) so as to stop drive of the transport rollers, and accordingly, transportation of the sheets P is stopped in the sheet feeding device 10 according to the present exemplary embodiment. In contrast, when multifeed is not detected as a result of the detection of whether or not the multifeed state occurs performed by the ultrasonic wave sensor 50, drive of the transport rollers is continued so as to transport the sheet P downstream in the transport direction X along the transport path 20.

While each of the sheets P having been transported downstream step by step by the registration rollers 33 and the feed rollers 34 passes through the space between the platen member 39 and the second platen glass 72B, the linear light is radiated from the scanner light source 81 toward the front side of the sheet P through the second platen glass 72B. Part of the radiated light is reflected by an image held on the front side of the sheet P, and the reflected light reflected by the image held on the front side of the sheet P corresponds to the image held on the front side of the sheet P.

The reflected light reflected by the front side of the sheet P is supplied to the imaging lens 76 through the first mirror 75A, the second mirror 75B, and the third mirror 75C. The optical image having been reduced in size by the imaging lens 76 is formed on the CCD image sensor 77. The CCD image sensor 77 photoelectrically reads the optical image so as to obtain image information. The above-described image information is obtained during transportation of the sheet P in the transport direction X along the transport path 20. Thus, the image of a single page of the front side of the sheet P is read.

Each of the sheets P having passed through the space between the platen member 39 and the second platen glass 72B is guided along the inclined surface of the guide member 82 (see FIG. 1) so as to be fed to the output rollers 35. The output rollers 35 feed the sheet P to the ejection rollers 36 along the transport path 20. The ejection rollers 36 eject the sheet P to the read sheet containing unit 12.

While the sheet P is passing through part of the transport path 20 between the output rollers 35 and the ejection rollers 36, the back side of the sheet P passes through a position facing the second image reading unit 40. At this time, the second image reading unit 40 radiates the linear light extending in a direction perpendicular to the transport direction X of the sheet P toward the back side of the sheet P.

Part of the radiated light is reflected by an image held on the rear side of the sheet P, and the reflected light reflected by the image held on the rear side of the sheet P corresponds to the image held on the rear side of the sheet P. An image of the reflected light reflected by the back side of the sheet P is formed on the line sensor of the second image reading unit 40. The line sensor photoelectrically reads the image of the reflected light so as to obtain image information. This image information is obtained during transportation of the sheet P in the transport direction X. Thus, the image of a single page of the back side of the sheet P is read.

As described above, the image reading device 1 according to the present exemplary embodiment performs reading of an image on the front side of each of the sheets P in parallel with reading of an image on the back side of the sheet P in a single run of transportation of the sheet P. It is noted that, when reading an image only on the front side of the sheet P, the reading operation of the back side of the sheet P with the second image reading unit 40 is not performed.

In the case of stationary reading in which the sheet P is placed on the first platen glass 72A of the document table 71 and read in a stationary state without being transported, the full rate carriage 73 and the half rate carriage 74 are started to be moved in a direction in an image reading direction (a direction indicated by a hollow arrow in FIG. 1) at the speed ratio of 2:1 when the sheet P is set on the first platen glass 72A and reading is started in the scanner device 70.

At this time, as described above, the linear light is radiated from the scanner light source 81 of the full rate carriage 73 toward the sheet P. The linear reflected light reflected by the sheet P is then sequentially reflected by the first mirror 75A, the second mirror 75B, and the third mirror 75C in this order so as to be directed to the imaging lens 76. The image of the reflected light having been directed to the imaging lens 76 is reduced in size so as to be formed on a light receiving surface of the CCD image sensor 77. The above-described image reading operations are performed during the movements of the full rate carriage 73 and the half rate carriage 74 over the entirety of the sheet P. Thus, the image of a single page of the front side of the sheet P is read.

As described above, in the image reading device 1 according to the present exemplary embodiment, the sheet feeding device 10 detects whether or not the multifeed state of the sheets P occurs at a part of the transport path 20 having a curvature with the ultrasonic wave sensor 50 (see FIG. 2). In so doing, the orientation of the part T or the parts T (see FIG. 5) of the sheet P or the sheets P, which are subjected to the detection, relative to the ultrasonic wave sensor 50 is stabilized by the pressure devices 60. This may suppress variation of the orientation of the sheet P or the sheets P at the part T or the parts T relative to the ultrasonic wave sensor 50, and accordingly, may suppress variation in results of the detection of whether or not the multifeed state occurs performed by the ultrasonic wave sensor 50.

That is, since the transport path 20 has a curvature, the part T or the parts T of the sheet P or the sheets P where whether or not the multifeed state occurs is detected by the ultrasonic wave sensor 50 may be separated from the inner guide surface 22a by, for example, the stiffness of the sheet P itself or the sheets P themselves, and accordingly, the angle θ formed between the ultrasonic wave sensor 50 and the sheet P or the sheets P may vary.

However, in the sheet feeding device 10 according to the present exemplary embodiment, the pressure devices 60 may stabilize the orientation of the sheet P or the sheets P relative to the ultrasonic wave sensor 50 at the part T or the parts T of the sheet P or the sheets P where whether or not the multifeed state occurs is detected by the ultrasonic wave sensor 50. This may prevent or suppress variation of the angle θ formed between the ultrasonic wave sensor 50 and the sheet P or the sheets P. With the orientation of the sheet P or the sheets P relative to the ultrasonic wave sensor 50 stabilized, variation in results of the detection of whether or not the multifeed state occurs performed on the sheet P or the sheets P by the ultrasonic wave sensor 50, the variation occurring when the orientation of the sheet P or the sheets P is not stabilized, may be suppressed.

When the sheet P or the sheets P are transported in the transport direction X along the inner guide surface 22a, the roller 64 is rotated about the shaft portions 63 by the movement of the sheet P or the sheets P and does not impede a transport operation of the sheet P or the sheets P.

Furthermore, since the sheet feeding device 10 according to the present exemplary embodiment presses the roller 64 against the inner guide surface 22a, which is a surface, the orientation of the sheet P or the sheets P is restrained in a unique orientation along the inner guide surface 22a as illustrated in FIG. 8. Assuming that the following structure is adopted: the sheet P or the sheets P are nipped between the pair of rollers 64 from both the sides of the sheet P or the sheets P so as to stabilize the orientation of the sheet P or the sheets P. In this case, since peripheral surfaces of both of the pair of two rollers 64 are circumferential surfaces, a contact position where both the rollers 64 are in contact with each other tends to vary. That is, with the structure in which the pair of rollers 64 press the sheet P or the sheets P, slight variation in the contact position changes the direction of a common tangent to the two rollers 64, and accordingly, the orientation of the sheet P or the sheets P varies relative to the inner guide surface 22a.

However, since the structure in which the sheet P or the sheets P are pressed against the inner guide surface 22a by the roller 64 is adopted for the sheet feeding device 10 according to the present exemplary embodiment, the orientation of the sheet P or the sheets P may be easily stabilized compared to the structure in which the pair of rollers 64 press the sheet P or the sheets P.

In the sheet feeding device 10 according to the present exemplary embodiment, as illustrated in FIG. 2, the transport device 30 transports each of the sheets P (see FIG. 1) along the inner guide surface 22a, which is a convex surface and the pressure devices 60 press the sheet P or the sheets P against the convex inner guide surface 22a. That is, the sheet feeding device 10 according to the present exemplary embodiment is configured so as to guide the sheet P along the inner guide surface 22a throughout the transport path 20.

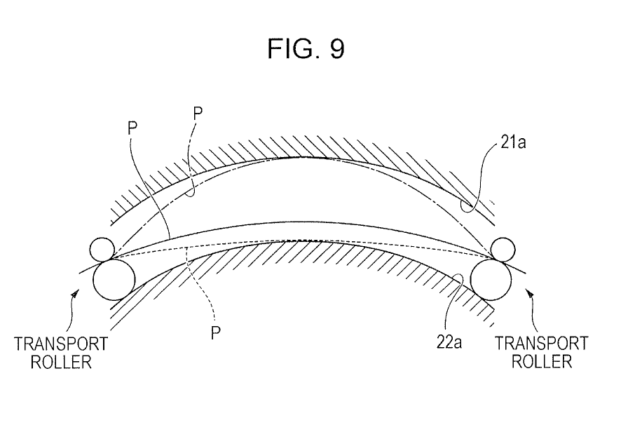

Here, FIG. 9 is a schematic view illustrating a state of the sheet P or the sheets P bent between the two of the transport rollers while being supported by the two transport rollers. In FIG. 9, a solid line indicates a state of the sheet P or the sheets P not pressed by the pressure devices 60 (see FIG. 6), a broken line indicates a state of the sheet P or the sheets P pressed against the inner guide surface 22a by the pressure devices 60, and a one-dot chain line indicates a state of the sheet P or the sheets P pressed against the outer guide surface 21a by the pressure devices 60.

As illustrated in FIG. 9, the curvature of the sheet P or the sheets P is larger in the case where the sheet P or the sheets P are pressed against the outer guide surface 21a by the pressure devices 60 than in the case where the sheet P or the sheets P are pressed against the inner guide surface 22a. In the case where the sheet P or the sheets P have a large curvature, it is more likely that smooth transportation of the sheet P or the sheets P is impeded than in the case where the sheet P or the sheets P have a small curvature. Also, in the case where the curvature of the sheet P or the sheets P irregularly varies, it is more likely that smooth transportation of the sheet P or the sheets P is impeded than in the case where there is no irregular variation of the curvature.

In the sheet feeding device 10 according to the present exemplary embodiment, the transport device 30 transports the sheets P along the convex inner guide surface 22a. Thus, compared to the case where a structure in which the sheet P or the sheets P are pressed against the concave outer guide surface 21a by the pressure devices 60 is adopted, irregular variation of the curvature of the sheet P or the sheets P while the sheet P or the sheets P are being transported through the transport path 20 or an increase in the curvature (a decrease in the radius of curvature) of the sheet P or the sheets P may be suppressed. Accordingly, in this sheet feeding device 10, it may be less likely that smooth transportation of the sheet P or the sheets P is impeded than in the sheet feeding device in which the sheet P or the sheets P are pressed against the outer guide surface 21a by the pressure devices 60.

The pressure devices 60 of the sheet feeding device 10 according to the present exemplary embodiment are provided at two positions in the width direction W of the sheet P such that the part T or the parts T of the sheet P or the sheets P where whether or not the multifeed state occurs is detected by the ultrasonic wave sensor 50 are interposed between the two positions. Thus, the sheet feeding device 10 according to the present exemplary embodiment may stabilize the orientation of the sheet P or the sheets P at the part T or the parts T without directly pressing the part T or the parts T of the sheet P or the sheets P where whether or not the multifeed state occurs is detected by the ultrasonic wave sensor 50.

### Variant of Arrangement of Pressure Devices

As illustrated in FIG. 4, the pressure devices 60 of the sheet feeding device 10 according to the above-described exemplary embodiment are provided on both the sides adjacent to the part T or the parts T of the sheet P or the sheets P where whether or not the multifeed state occurs is detected by the ultrasonic wave sensor 50 in the width direction W of the sheet P so as to interpose the part T or the parts T therebetween. However, the recording sheet transport device and the image reading device according to the present invention are not limited to the above-described exemplary embodiment. The pressure devices 60 may be disposed at positions other than the above-described positions.

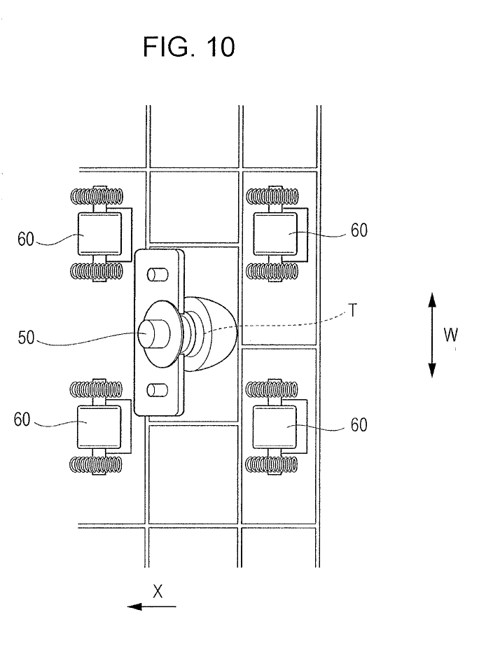

FIG. 10 is a plan view of a portion of the sheet feeding device 10 corresponding to FIG. 3 illustrating a structure in which the pressure devices 60 are provided at four positions adjacent to the part T or the parts T of the sheet P or the sheets P so as to interpose the part T or the parts T therebetween in both the transport direction X and the width direction W of the sheet P, the four positions being positions where whether or not a multifeed state occurs is detected by an ultrasonic wave sensor 50.

In the recording sheet transport device and the image reading device having the structure in which, as illustrated in FIG. 10, the pressure devices 60 are provided at the four positions adjacent to the part T or the parts T of the sheet P or the sheets P so as to interpose the part T or the parts T therebetween in the transport direction X and the width direction W of the sheet P (see FIG. 1), the four positions of the sheet P or the sheets P around the part T or the parts T where whether or not the multifeed state occurs is detected by the ultrasonic wave sensor 50 are pressed by the pressure devices 60. This may also stabilize the orientation of the part T or the parts T of the sheet P or the sheets P relative to the ultrasonic wave sensor 50, and accordingly, operations and effects that are the same as or similar to those of the sheet feeding device 10 and the image reading device 1 according to the above-described exemplary embodiment may also be performed and produced.

Furthermore, in the recording sheet transport device and the image reading device according to this variant, the positions where the pressure devices 60 are disposed are not necessarily limited to the positions that are the same as that of the part T or the parts T of the sheet P or the sheets P in the transport direction X. Thus, with the recording sheet transport device and the image reading device according to this variant, versatility of arrangement of the pressure devices 60 may be improved.

Although the sheet feeding device 10 according to the above-described exemplary embodiment is configured as part of the image reading device 1, the sheet feeding device 10 is not necessarily configured as the part of the image reading device 1. The sheet feeding device 10 may be a stand-alone recording sheet transport device separated from the scanner device 70.

Accordingly, the sheet feeding device 10 may also be applied as, for example, a recording sheet transport unit such as a sheet supply unit of an image forming apparatus that includes an image forming unit that forms images on the sheets P. In this case, the image forming unit is disposed downstream of the pressure devices 60, which are each serving as the orientation stabilizing device, in the transport direction X of the sheet P in the transport path 20.

The transport path 20 of the above-described sheet feeding device 10 includes the following two guide surfaces: that is, the outer guide surface 21a that faces the front side of each of the sheets P near the ultrasonic wave sensor 50 and the inner guide surface 22a that faces the back side of each of the sheets P near the ultrasonic wave sensor 50. However, the transport path 20 may include at least one of the outer guide surface 21a and the inner guide surface 22a.

It is sufficient that the pressure devices 60 that press the sheet P or the sheets P and the guide surfaces (the inner guide surface 22a and the outer guide surface 21a) be disposed near the ultrasonic wave sensor 50. For example, these pressure devices 60 and the guide surfaces may be disposed at the same position as the ultrasonic wave sensor 50 in the transport direction X and shifted from the ultrasonic wave sensor 50 in the perpendicular direction (the width direction W of the sheet P), or may be disposed at positions slightly upstream or downstream of the ultrasonic wave sensor 50 instead of being at the same position as the ultrasonic wave sensor 50 in the transport direction X. That is, it is sufficient that the pressure devices 60 and the guide surfaces be disposed at positions where the pressure devices 60 and the guide surfaces may regulate the orientation of the part T or the parts T of the sheet P or the sheets P detected by the ultrasonic wave sensor 50 relative to the ultrasonic wave sensor 50.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording sheet transport device having a transport path having a curvature, the device comprising:
a multifeed detector that detects a multifeed state in which two or more recording sheets are superposed on one another while the two or more recording sheets are being transported; and
an orientation stabilizing device that stabilizes an orientation of parts of the two or more recording sheets, at which the multifeed state is detected by the multifeed detector, relative to the multifeed detector.

2. The recording sheet transport device according to claim 1,
wherein the transport path is defined by a guide surface that guides the two or more recording sheets at at least one of sides of the two or more recording sheets near the multifeed detector, and
wherein the orientation stabilizing device is a pressure device that presses the two or more recording sheets against the guide surface.

3. The recording sheet transport device according to claim 2,
wherein the pressure device presses the two or more recording sheets against the guide surface provided inside the transport path having a curvature.

4. The recording sheet transport device according to claim 2,
wherein the guide surface is a convex surface,
wherein a transport device that transports the two or more recording sheets is provided along the convex surface, and
wherein the pressure device presses the two or more recording sheets against the convex surface from an outside of the convex surface.

5. The recording sheet transport device according to claim 2,
wherein a plurality of the pressure devices are provided, the plurality of pressure devices being arranged in a direction intersecting a direction in which the two or more recording sheets are transported so as to interpose the parts of the two or more recording sheets, at which the multifeed state is detected by the multifeed detector, between the plurality of pressure devices.

6. The recording sheet transport device according to claim 2,
wherein a plurality of the pressure devices are provided, the plurality of pressure devices being arranged in a direction in which the two or more recording sheets are transported so as to interpose the parts of the two or more recording sheets, at which the multifeed state is detected by the multifeed detector, between the plurality of pressure devices.

7. An image reading device comprising:
a recording sheet transport unit having a transport path having a curvature, the recording sheet transport unit including
a multifeed detector that detects a multifeed state in which, out of recording sheets, two or more of the recording sheets are superposed on one another while the two or more of the recording sheets are transported; and
an orientation stabilizing device that stabilizes an orientation of parts of the two or more of the recording sheets, at which the multifeed state is detected by the multifeed detector, relative to the multifeed detector, and
an image reading unit that reads an image recorded on each of the recording sheets, the image reading unit being disposed in part of the transport path downstream of the orientation stabilizing device in a direction in which the recording sheets are transported.
